(19) United States
(12) Patent Application Publication
(10) Pub. No.: US 2026/0261337 A1
(43) Pub. Date: Sep. 3, 2026

(54) MONITORING SUBMARINE CABLE EXPOSURE

(71) Applicant: FIBER SENSE LIMITED, Mosman, NSW (AU)

(72) Inventors: Andrew MCNAB, San Francisco, CA (US); Peter HUBBARD, Oaklan, CA (US); Nathaniel LINDSEY, Oakland, CA (US); Mark Andrew ENGLUND, Sydney (AU)

(21) Appl. No.: 19/163,826

(22) PCT Filed: Mar. 8, 2024
(86) PCT No.: PCT/AU2024/050201

§ 371 Date: Sep. 9, 2025

Related U.S. Application Data
(60) Provisional application No. 63/451,515, filed on Mar. 10, 2023.

(51) Int. Cl. H04B 10/071; G01L 1/24; G02B 6/50

(52) U.S. Cl. CPC H04B 10/071; G01L 1/242; G02B 6/504; G02B 6/506

(57) ABSTRACT

Method and system for determining an exposure point along a buried submarine cable are disclosed. The method includes transmitting interrogating signals into a sensing optical fibre extending the length of the submarine cable, and receiving backscattered signals from the sensing optical fibre in response to the interrogating signals. The method further includes processing the backscattered signals to determine temporal and/or spatial variation in strain along the sensing optical fibre, wherein a determined spatial and/or temporal variation in the strain is indicative of an exposure point and its location along the length of the buried submarine cable.

### TECHNICAL FIELD

Aspects of the present disclosure are generally directed to methods and/or systems for monitoring submarine assets such as cables and in particular are related to methods and/or associated systems for monitoring exposure of submarine assets.

### BACKGROUND

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

Burial of telecommunication and/or power cables underwater is often required by law or strongly recommended in many regions especially near shores and where cables are laid in shallow water, for example in water that is less than 500-1000 meters deep.

To comply with such requirements, optical cables are often buried at a depth of about 1 meter or more. However, in some areas where a cable is required to be buried, it may not be buried. This may happen for a variety of reasons. For example, cables may not be buried because of high burial costs, or because the cables lie at a water depth that is far from shore and therefore unreachable by fishing vessels or by other external aggression means—and therefore generally at a low risk of being damaged. Alternatively, cables may be initially buried, but may become unburied over time, e.g., because of the activity level of nearshore sediments around the cable, because of seafloor currents, and/or storm activity. For instance, during storms, high wave activity has been seen to dramatically change cable exposure near seashores.

It may be desirable to monitor the buried/unburied status of submarine optical cables, especially in areas of high activity where there is a chance of external aggressor's (e.g., fishing vessels or fish) damaging the optical cable. Such information can then be used to mitigate risks and hazards to the cables thereby increasing the longevity of the cables.

### SUMMARY

According to a first aspect of the present disclosure, there is provided a method for determining an exposure point along a buried submarine cable. The method includes: transmitting interrogating signals into a sensing optical fibre extending the length of the submarine cable; receiving backscattered signals from the sensing optical fibre in response to the interrogating signals; and processing the backscattered signals to determine temporal and/or spatial variation in strain along the sensing optical fibre, wherein a determined spatial and/or temporal variation in the strain is indicative of an exposure point and its location along the length of the buried submarine cable.

Determining the spatial and/or temporal variation in the strain includes determining variations in a true amplitude and a duration of the backscattered signals at locations along the length of the optical sensing fibre. Further, the exposure point is detected by determining that the true amplitude of the backscattered signal at a location along the length of the optical sensing fibre is above a threshold value and remains above the threshold value for a threshold duration of time. In some embodiments, the threshold value is determined based on a baseline strain value for the corresponding location along the length of the optical sensing fibre. The baseline strain value may have been determined when the submarine cable was buried.

In an embodiment, determining the spatial and/or temporal variation in the strain includes: determining variations in a true amplitude and a duration of the backscattered signals at locations along the length of the optical sensing fibre.

In an embodiment, the method further includes detecting the exposure point by determining that the true amplitude of the backscattered signal at a location along the length of the optical sensing fibre is above a threshold value and remains above the threshold value for a threshold duration of time.

In an embodiment, the threshold value is determined based on a baseline strain value for the corresponding location along the length of the optical sensing fibre, the baseline strain value determined when the submarine cable was buried.

In an embodiment, the method further includes determining the location of the exposure point based on the timing of receiving the backscattered signal.

In an embodiment, the method further includes determining a risk score associated with the detected exposure point.

In an embodiment, determining the risk score comprises: determining a geographical location of the exposure point; and determining a risk score associated with the geographical location based on contextual data.

In an embodiment, the method further comprises generating an alert upon determining that the risk score of the detected exposure point is above a threshold risk score.

In an embodiment, the method further comprises generating a cable risk map based on the detected exposure point and communicating the cable risk map to an operator of the submarine buried cable.

According to a second aspect of the present disclosure, there is provided a distributed fiber optic sensing (DFOS) system, including: a light source configured to transmit interrogating signals into a sensing optical fibre extending the length of the submarine cable; a photodetector configured to receive backscattered signals from the sensing optical fibre in response to the interrogating signals; and a processing unit configured to process the backscattered signals to determine temporal and/or spatial variation in strain along the sensing optical fibre, wherein a determined spatial and/or temporal variation in the strain is indicative of an exposure point and its location along the length of the buried submarine cable.

The DFOS system may be configured to determine variations in a true amplitude and a duration of the backscattered signals at locations along the length of the optical sensing fibre and detect the exposure point by determining that the true amplitude of the backscattered signal at a location along the length of the optical sensing fibre is above a threshold value and remains above the threshold value for a threshold duration of time. The threshold value may be determined based on a baseline strain value for the corresponding location along the length of the optical sensing fibre. For example, the threshold value may be set as the baseline strain value. The baseline strain value may be determined when the submarine cable was buried.

In an embodiment, to determine the spatial and/or temporal variation in the strain, the processing unit is further configured to determine variations in a true amplitude and a duration of the backscattered signals at locations along the length of the optical sensing fibre.

In an embodiment, the processing unit further configured to detect the exposure point by determining that the true amplitude of the backscattered signal at a location along the length of the optical sensing fibre is above a threshold value and remains above the threshold value for a threshold duration of time.

In an embodiment, the threshold value is determined based on a baseline strain value for the corresponding location along the length of the optical sensing fibre, the baseline strain value determined when the submarine cable was buried.

In an embodiment, the processing unit is further configured to determine the location of the exposure point based on the timing of receiving the backscattered signal.

In an embodiment, the processing unit is further configured to determine a risk score associated with the detected exposure point.

In an embodiment, determining the risk score comprises: determining a geographical location of the exposure point; and determining a risk score associated with the geographical location based on contextual data.

In an embodiment, the processing unit is further configured to generate an alert upon determining that the risk score of the detected exposure point is above a threshold risk score.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a schematic of an example submarine cable.

FIG. 2A illustrates an example of a system for distributed acoustic sensing.

FIG. 2B illustrates an example of the electrical signal generated by the system of FIG. 2A over time.

FIG. 3 is a schematic diagram of a disclosed method of distributed acoustic sensing to detect cable exposure according to some aspects of the present disclosure.

FIG. 4A illustrates schematically a transmission sequence of interrogating optical signals at multiple instants and a sequence of corresponding observation windows.

FIG. 4B illustrates schematically an example of amplitude vs distance plots of returned optical signals.

FIG. 5A illustrates an exemplary power spectral density (PSD) plot generated based on returned optical signals according to some embodiments of the present disclosure.

FIG. 5B illustrates an exemplary exposure likelihood plot determined based on the PSD plot of FIG. 5A.

FIG. 6 is an exemplary plot showing determination of cable exposure points using DFOS and DTS methods.

### DETAILED DESCRIPTION

Typically, submarine telecommunication and/or power cables face four main types of hazards: manufacturing defects, natural hazards, external aggression, and abrasion. Manufacturing defects are usually controlled by enforcing strict quality protocols and standards across the industry. Natural hazards such as submarine landslides, tsunamis, submarine volcanoes, earthquakes are often difficult to predict but can be mitigated as best as possible through careful route planning—e.g., not laying cables in regions that are known to be prone to landslides, earthquakes, etc. Hazards due to external aggression and/or abrasion on the other hand are both much more difficult to sense and mitigate.

External aggression relates to any kind of damage to a cable due to external activity, e.g., fishing or trawling nets getting caught in exposed cables, vessel anchors dragging along the seafloor and accidently damaging exposed cables on the seabed, etc. In the case of external aggression, cable exposure offers a point of potential snag that would otherwise not be present if the cable was buried under the ocean floor. Abrasion is also related to exposure, because when the cable is loose, it is free to move around on the seafloor and this can lead to excessive cable wear, insulation degradation, e.g., due to friction on the surrounding rocks/coral, cable strumming or cable vibration (e.g., because the cable is pulled into tension between two points).

Both, aggression and abrasion hazards can be prevented by heavily insulating and/or armoring the cables with layers of strong materials such as plastics, gels, and/or steel. Although this may be effective, it increases the costs of laying cables substantially.

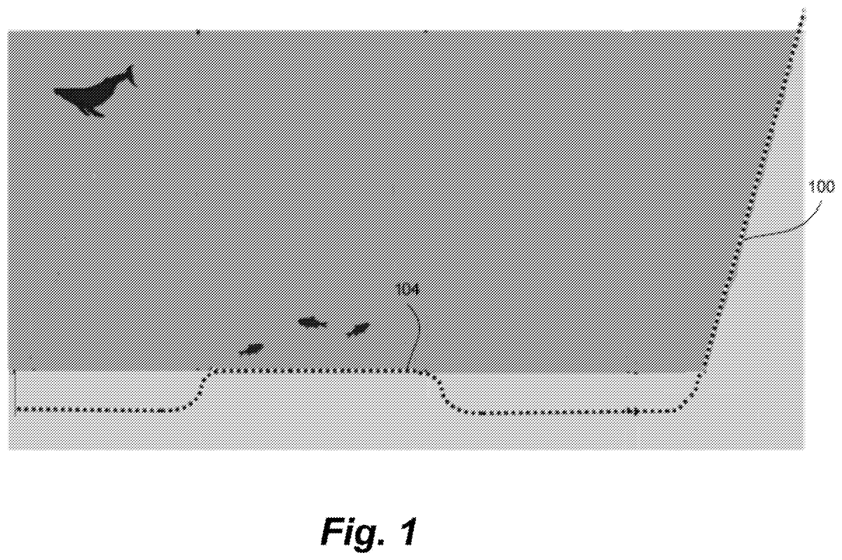

Another way to reduce aggression and/or abrasion hazards is by burying the cable under the ocean floor as described previously. FIG. 1 illustrates an example cable (e.g., a telecommunications cable) 100. The cable 100 is buried about 1 meter under the ocean floor. However, due to currents, storms, marine activity, etc., the cable 100 may become unburied over time. FIG. 1 illustrates that the cable 100 has become unburied in one locations—104. This location may be referred to as an exposure point in this disclosure. If the exposure point 104 is left unburied, the cable 100 in this region may become abraded over time and/or may be subjected to aggression from fishing vessels, marine life, movement, etc. Accordingly, it is desirable to monitor the exposure of submarine cables. Suitable action can then be taken—e.g., if it is determined that one or more portions of a cable have become unburied and are exposed close to land, steps can be taken to rebury those portions of the cable or to alert fishermen in the neighborhood about those exposure points in real time.

There are three common techniques utilized today to assess and monitor submarine cable exposure. In one technique, a campaign-style survey of the cable asset is conducted periodically. This might involve scuba divers, or remotely operated vehicles visually surveying the cable route for cable exposure points. As can be appreciated, this method is expensive and sporadic. A cable may become exposed in the period between two surveys and this may only be discovered in the next survey.

In another technique, multi-beam sonar may be used to map the seafloor and submarine cable assets. Multi-beam sonar surveys typically use a source-receiver array mounted directly on a ship's hull. This way of surveying a cable asset is capital-intensive and time-consuming. Further, as these surveys depend on passing ships, logistically, the surveys cannot be conducted routinely or even annually to provide the data required to alert fisherman about exposure points in real-time.

In the third technique, cable exposure points are assessed along a submarine cable using a Distributed Temperature Sensing (DTS) system. These systems work based on the presumption that when a portion of an optical cable is exposed or unburied, the temperature of the optical cable changes in that portion as compared to the unexposed or buried portions. For instance, the temperature may drop in exposed portions due to the presence of circulating ocean environment. The DTS system may be used to detect changes in temperature along an optical cable and any detected variations in temperature may be utilized to determine exposure sites.

In such systems, one or more optical fibres may be included in any submarine cable system. Optical signals may be transmitted into the optical fibres, and Raman backscattering of the transmitting signals may be analyzed to detect potential exposure sites. In particular, in a DTS system, the ratio of Stokes to Anti-Stokes Raman scattering is used to determine the absolute temperature along an optical fibre. If the temperature of the optical cable drops in certain regions of the optical cable, those regions can be assessed to be exposure points.

Although DTS can be used to determine exposure points remotely, it suffers from one or more issues. For instance, DTS can usually only cover a short distance (e.g., in the range of 30-40 km). Accordingly, it cannot be used to identify exposure points that are further away from the shore. Furthermore, DTS commonly requires dedicated multimode fibre for the sensing element. Multimode fibres are less common in the marine environment and therefore DTS cannot be implemented with pre-existing cables laid in the marine environment.

Aspects of the present disclosure provide a new method to assess cable exposure based on Distributed Fibre Optic Sensing (DFOS). The presently disclosed methods and systems can utilize single mode optical fibres for the detection and can detect cable exposure points along greater distances—e.g., in excess of a 100 kms. Further, aspects of the present disclosure can provide end users with a way to determine submarine cable risk and then mitigate or prevent damages from happening almost in real time.

In order to do so, the disclosed systems and methods use DFOS over existing subsea optical fibres to estimate exposure of cables in a distributed fashion along the length of the cables. In some embodiments, the methods and/or systems use Rayleigh and/or Brillouin scattering in an optical fibre to assess dynamic strain or static strain along an optical fibre to determine if the optical fibre has been exposed (e.g., an unburied) or not. In particular, the measured strain provides information about the vibrations experienced by the optical cable. It is presumed that cables that are exposed or not buried will experience larger strains from environmental phenomena (e.g., passing ships, storms, waves, etc.) whereas buried cables may experience lower strains from such environmental phenomena as these are buried under the ocean floor. Further, cables that are buried under the ocean floor will have certain vibration dampening characteristics based on the dampening properties of the material forming the seabed and cables that are unburied or exposed will have different vibration dampening characteristics based on the dampening properties of the water. These differences or variations in strain or vibration dampening values may be utilized by the presently disclosed systems and methods to determine whether portions of a cable are exposed or not and also determining the exact location of such exposure points.

In one example, DFOS data is recorded from the shore side of a single mode optical fibre that has been incorporated into a subsea cable wet plant or separated but located near a subsea cable asset. DFOS data is collected and used to estimate subsea cable burial state or state change in a distributed fashion (based on the detected strain in the DFOS data). Next, a determination is made whether any portions of the monitored cable are likely exposed based on the DFOS data. Then, if a determination is made that one or more portions of the monitored cable are likely exposed, a cable risk map is generated. The cable risk map may indicate the actual geographical locations of potential exposure and a risk level associated with the exposure. In some embodiments, the cable risk map may include contextual information, such as the depth of the water above the likely cable exposure point, the frequency of marine vessel paths crossing over the likely cable exposure point, frequency of high risk AIS navigation status alerts, storm and high wave activity forecasts, history of cable strike in the region, and/or cable owner risk tolerance. Finally, based on the cable risk map, a warning may be issued to the cable owner or cable operator or a cable infrastructure user for consideration of mitigation strategies—such as reburying the cable or avoiding the site of the potential exposure. Optionally, an alert may be automatically communicated, e.g., through an automatic identification system (AIS) to alert potential marine vessels in the region about any locations that may have exposed cables.

These and other aspects of the present disclosure will be described in detail in the following sections.

### Example DAS System

Generally speaking, a DAS system includes an interrogation unit and a sensing cable. The interrogation unit continuously injects short pulses of optical signals into the sensing cable. When light passes through the fibre cores of the sensing cable, the incident light is scattered in different directions due to spatial variations in the refractive index of the fibre cores and different kinds of scattered light (such as Rayleigh, Raman and Brillouin) are generated. When the optical fibres are disturbed and subjected to strain and/or vibrations, the properties of the scattered light change (wavelength, light intensity, frequency, etc.). By analyzing certain characteristics of the returned scattered light, changes in various physical parameters (e.g., axial strain, strain rate, vibration dampening) can be revealed. Further, phase information of Rayleigh scattered light can be analyzed to obtain dynamic strain (vibrations or acoustic waves) measurements.

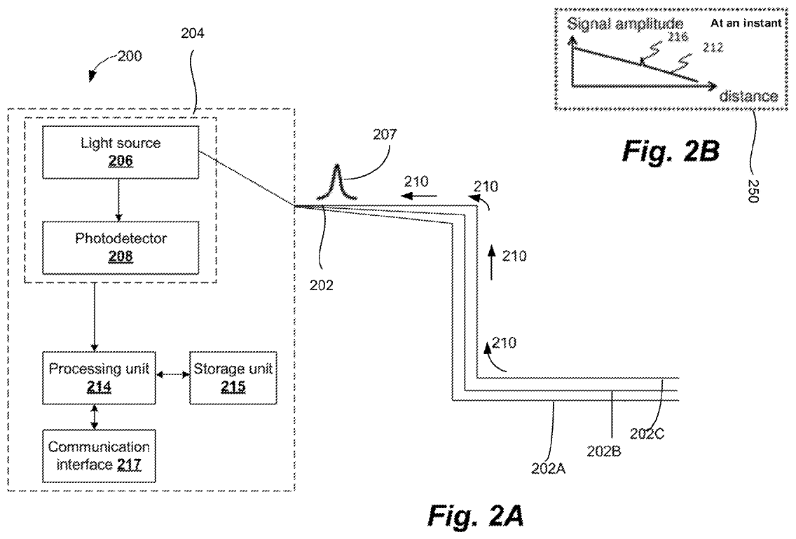

FIG. 2A illustrates an example DAS system 200 that can be utilized for the presently disclosed methods. The DAS system 200 may be optically coupled to one or more optical fibres 202. In the present example, it is operatively coupled to three optical fibres 202A, 202B, and 202C. However, it will be appreciated that in other embodiments, it may be coupled to more or fewer optical fibres without departing from the scope of the present disclosure. The optical fibres 202 may be integrated with or otherwise in the vicinity of one or more submarine cable assets and may be present along the entire length of the one or more cable assets. In one example, the optical fibres may be bundled together with the cable assets and the entire bundle may be encapsulated in protective shielding. Further, the fiber can be laid in any orientation, or even wrapped around a central cylinder in a helical fashion to introduce more than one component of motion/deformation to each gauge length of the subsequent DFOS measurement. Further still, existing optical fiber laid for a different purpose can be utilized for the DFOS measurement. Multiple fibres can be joined in series and used for DFOS with one instrument, or multiple DFOS channels (analyzed with the same or separate DFOS instruments) can be used to record DFOS data within the same vicinity.

The DAS system 200 includes a coherent optical time-domain reflectometer (C-OTDR) 204. The C-OTDR 204 includes a light source 206 to emit an optical interrogation field in the form of short optical pulses 207 to be sent into each of the optical fibres 202A, 202B, and 202C.

The light source 206 is a laser source, while the optical pulses transmitted by the laser source can be simple pulses, chirped pulses, or continuous waves. Furthermore, the optical pulses 207 can be in the infrared or near infrared frequency range.

The C-OTDR 204 also includes a photodetector 208 configured to detect optical signals returning from or backscattered by the optical fibres 202A, 202B and 202C. The backscattered signals may include Rayleigh, Brillouin, and/or Raman scattering. Rayleigh scattering is a form of an elastic scattering of light that conserves the kinetic energy of the incidental particles of the optical fibre in which the scattering takes place—that is, in this type of scattering the scattered photons have the same energy as the incident photons. Raman scattering is a form of inelastic scattering of light that does not conserve the kinetic energy of the incidental particles. Brillouin scattering is a “photon-phonon” interaction as annihilation of an incidental photon creates a Stokes photon and a phonon simultaneously. Both Raman and Brillouin scattering produce components canned Stokes and Anti-Stokes components.

Generally speaking, the returning light 210 is scattered in a distributed manner in the optical fibre 202. In some embodiments, the photodetector 208 passes the detected optical signals 210 to the processing unit 214 directly. In other embodiments, the photodetector 208 may convert the optical signals 210 into electrical signals such that an amplitude of the electrical signal 212 is proportional to the reflected optical intensity resolved over time. The time scale may be translated to a distance scale relative to the photodetector 208. FIG. 2B illustrates a schematic plot 250 of the amplitude of an optical signal over distance at one particular instant.

Returning to FIG. 2A, the DAS system 200 also includes a processing unit 214, within or separate from the C-OTDR 204. The processing unit 214 may be configured to process the returned optical signals from the optical fibres and store the processed data as DFOS data. In some embodiments, the processing unit 214 may be an optical processor that analyses the received optical signal optically. In other embodiments, the processing unit 214 may be a digital processor that converts the electrical signal received from the photodetector 208 into digital DFOS data and then stored this data. As referred to herein, DFOS data includes values about the state of an optical fiber for a particular time sample at all sensor positions in the fiber.

In certain embodiments, the processing unit 214 determines the dynamic strain or static strain along the optical fibre using the DFOS data.

In certain examples, input pulses 207 may be transmitted continuously in the optical fibre, DFOS data may be continuously updated, and the dynamic or static strain may also be computed continuously from the DFOS data. In other examples, the input pulses may be transmitted periodically (e.g., every few hours or days) and the DFOS data may be updated at the same frequency. The dynamic or static strain along the optic fibre may be computed at the same frequency or at a different frequency (e.g., every few days). In other embodiments, the strain values may be computed sporadically (e.g., in response to a known activity, e.g., a storm, an earthquake, a cyclone, etc.).

In addition to determining the strain values, the processing unit 214 may also be configured to determine whether any portions of the cable have been exposed (e.g., based on the strain data) and may also determine the geographical location of such likely exposures, and generate a cable risk map. The processing unit 214 may also be configured to automatically generate alerts based on the cable risk map.

The DFOS data or recording may be stored in a storage unit 215. The storage unit 215 may include volatile memory, such as random access memory (RAM) for the processing unit 214 to execute instructions, calculate, compute, or otherwise process data. The storage unit 215 may include non-volatile memory, such as a hard-disk drive for the processing unit 214 to store data before or after signal-processing and/or for later retrieval. The processing unit 214 and storage unit 215 and may be distributed across numerous physical units and may include remote storage, such as cloud storage, in which case the processing unit 214 and storage unit 215 may be more generally defined as a cloud computing service.

Finally, the system 200 also includes a communication interface 217 in communication with the processing unit 214 that may be utilized to communicate the cable risk map to cable operators and/or send alert signals to vessels in the vicinity of a likely cable exposure point. The communication interface may also be configured to receive requests for cable risk maps from one or more remote mobile or fixed terminals (not shown). Upon receiving a request for a risk map, the processing unit 214 may be configured to generate or retrieve (if already generated and stored) the requested risk map from the storage unit 215.

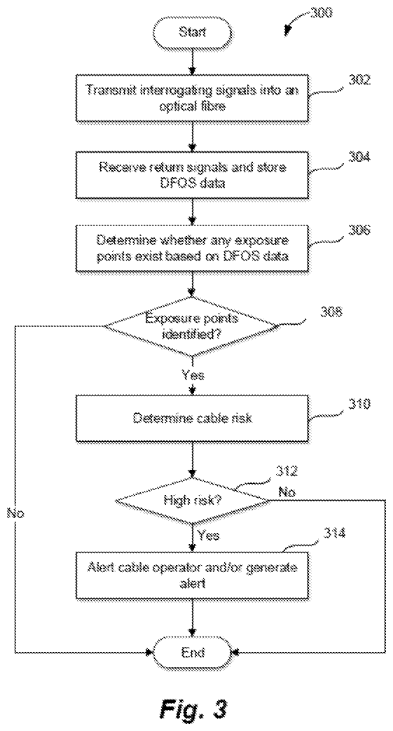

FIG. 3 is a flowchart illustrating an example method 300 for determining cable exposure according to some aspects of the present disclosure.

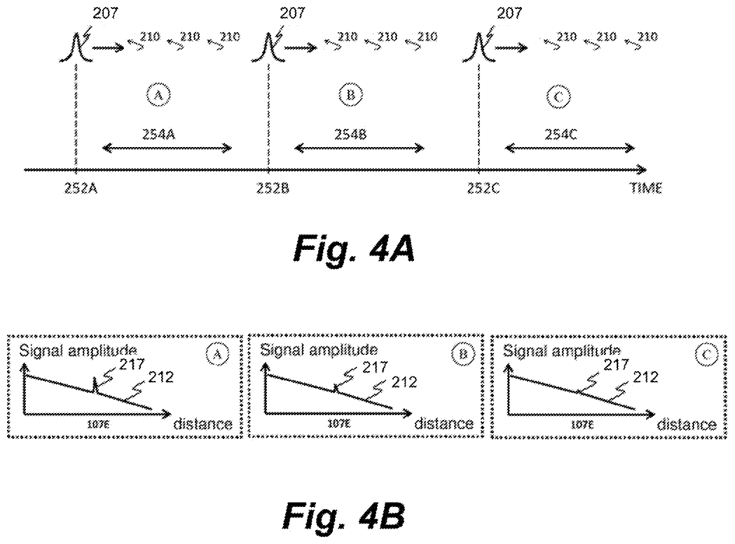

The method 300 commences at step 302, interrogating optical signals 207 are transmitted by the light source into the one or more optical fibres 202 that are integrated with or in the vicinity of one or more submarine cable assets. The interrogating signals may be transmitted at multiple instances. FIG. 4A illustrates example interrogating optical pulses transmitted by the light source at this step. In particular, FIG. 4A shows three time instants 252A, 252B, and 252C at which interrogating optical signals 207 are transmitted in the optical fibre.

Once the signals are transmitted, the method proceeds to step 304, where return signals 210 are received from the one or more optical fibres 202. FIG. 4A also shows the return signals. These return signals 210 are received in the observation periods 254A, 254B, and 254C between time instants 252A, 252B, and 252C. The time at which a return signal is received in the observation period indicates the location in the optical fibre from which the optical signal has been backscattered. The later a return signal is received in the observation period, the further away along the optical fibre the signal was backscattered from. Properties of the returned optical signal (e.g., wavelength, light intensity, frequency, phase, etc.) may change depending on the type of strain experienced by a section of the optical fibre. Accordingly, by analyzing the properties and the timing of the return signals, the processing unit can determine the strain experienced by particular portions of the optical fibre 202.

FIG. 4B shows the return optical signals 210 of FIG. 4A converted into electrical signals 212 by the photodetector 208. Each electrical signal 212 has an acoustic fluctuation 217. The different fluctuation peaks 217 shown in FIG. 4B are due to the different returning optical signals 210 that are generated due to different types of strain experienced by a section or sections of the optical fibre.

The electrical signals or the optical signals received from the optical fibres 202 represent DFOS data and this data may be stored by the processing unit 214 in the storage unit 215 at this step. It will be appreciated that steps 302 and 304 may be continuously repeated, periodically repeated, or performed at some other frequency. In other cases, these steps may be performed based on one or more trigger conditions—e.g., in response to a request for a cable risk map, one or more activities (e.g., storms, boat activity, etc.) being detected in the vicinity of the cable.

It will be appreciated that the frequency band of the DFOS data is 0.001-500 Hz, thus including a broad frequency range, from static or near-static timescales up to the Nyquist sampling frequency of the technique disclosed herein. For Rayleigh scattering methods such as DAS, the Nyquist frequency can be 1000 Hz for subsea cable spans of 50 km long. Thus, the DFOS measurement bandwidth covers multiple available environmental phenomena or signals created by an active source in the ocean environment.

For example, DFOS techniques are capable of detecting disturbances having a wide range of frequencies. This may be include, e.g., ocean noise (acoustic waves traveling in the water column), Scholte waves (interfacial waves traveling between the water column and the seafloor), ocean loading (coupling of the ocean surface gravity waves) or earthquake seismic waves (elastic waves moving through the solid earth). The DFOS techniques described herein can also detect passing marine vessels by altering the frequency of the input pulses such that it is in the range of the frequency of marine vessels.

At step 306, the exposure likelihood of one or more submarine cables is determined from the stored DFOS data. To this end, the processing unit first determines the static or dynamic strain experienced by the optical cable based on environmental conditions (e.g., passing ships, waves, etc.) along the length of the cable for a particular period of time. Any known techniques may be utilized to determine the strain from the DFOS data without departing from the scope of the present disclosure.

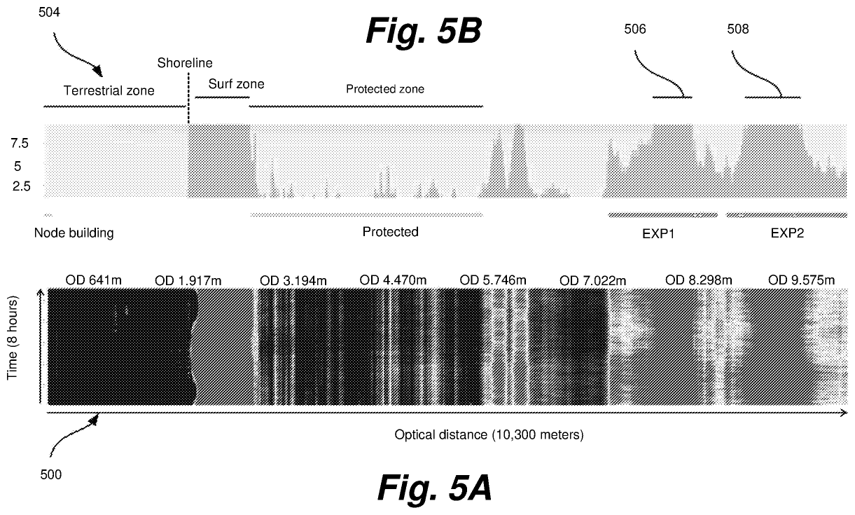

The processing unit 214 then computes the power spectral density along the length of the optical fibre. FIG. 5A illustrates the power spectral density of the DFOS data associated with a given optical fibre over 8 hours. The horizontal axis of plot 500 represents position along a sensing optical fibre 202 and the vertical axis represents time (e.g. 8 hours in this example). The color-coded signals of the plot 500 represent acoustic intensities and/or strain values. In particular, the grey portions of the plot indicate high signal amplitudes (or high strain), black portions represent low signal amplitudes (or low strain), and white portions represent intermediate signal amplitudes (or intermediate strain).

From the spectral power density plot, the processing unit 214 can determine locations of likely exposure points. For example, the white and grey portions in the power spectral map indicate higher strain than the black portions and may indicate potential exposure points. For more accuracy, the processing unit 214 may compute a statistical trace of the DFOS data that is computed from the power spectral density plot. The statistical trace shows the optical distance along the y axis and shows a true amplitude of the DFOS signal along the x axis.

The true amplitude is calculated by treating the optical fibre cable as an array of sensing points and measuring the amplitude of the backscattered signals at each position along the array. Each array of sensing points is a short segment (also referred to as gauge length) of the fibre, of 1-30 meters length, utilized as individual strain sensing channels that generates an array-type measurement of the true amplitude from a simple optical fibre.

In particular, the true amplitude is estimated using the likelihood function between two points (along the optical fibre) between which changes of amplitude in the strain data have been recorded (referred to as gauge length). Alternatively, the true amplitude can be estimated via maximum likelihood envelope estimator on the amplitude of the DFOS signal.

The statistical trace may be used as a proxy for exposure likelihood. Any known low strain zones (e.g., terrestrial zones or protected zones, i.e., where the cable is in a protective enclosing) or high strain zones (e.g., surf zones) may be labelled in the statistical trace and masked. All other portions of the statistical trace that exceed a pre-defined true amplitude threshold and minimum width criteria may be labelled as potential exposure points as these points experience higher strain than their neighboring regions for extended periods of time.

FIG. 5B illustrates an example statistical trace 504 generated from the PSD plot of FIG. 5A. In this example, the terrestrial zone, surf zone, and protected zones are labelled. These zones may be masked. All other portions of the statistical trace that exceed a pre-defined signal amplitude threshold of eg 10 units and minimum width criteria may be labelled as potential exposure points. In FIG. 5B, there are two points 506, 508 that include high amplitude signals exceeding 10 units for at least a minimum width (approximately 35 m) and these portions 506, 508 are labelled as potential exposure points.

In some embodiments, a statistical likelihood may be computed by the processing unit 215 to extract cable burial condition from DFOS data on a single gauge length basis. Alternatively, a statistical envelope moving maximum estimator on the true amplitude of the DAS signal may be computed. In particular, the processing unit 215 computes the true amplitude of the recorded acoustic data along the optical fibre cable, specifically in a neighborhood of a few hundred meters of optical distance.

At step 308 a determination is made whether any exposure points were identified at step 306. If no exposure points are identified, method 300 ends. Alternatively, if one or more potential exposure points are identified along a buried submarine cable, the method proceeds to step 310, where the processing unit 214 determines the risk associated with the likely exposure of the identified exposure points. To do so, the processing unit 214 determines the geographical location of the exposure points. This may be done by determining the distance along the optical fibre of the exposure point and determining the location of the optical cable and its path along the ocean floor. In some examples, the location information may be available in the storage unit 215 or may be retrieved from an external source.

Once the geographical location of the exposure points are determined, the processing unit may determine a risk score associated with the exposure point. In particular, it determines the risk of leaving the cable unexposed in that geographical location. This risk score may be computed based on contextual information about the geographical location such as water depth at that location, frequency of marine vessel path crossings that geographical area, frequency of high risk AIS navigation status alerts being generated in that area, storm and high wave activity forecasts for that area, history of cable strikes in the region, etc.

If the processing unit 214 determines that the location of the cable exposure is a low risk area it may associate a low risk score with the exposure point. Otherwise, if the processing unit determines that the location of the cable exposure is a high risk area (e.g., because it is a shallow area, an area that has a high frequency of large marine vessels crossings, or an area of high fishing activity), it may associate a high risk score with the exposure point. It will be appreciated that the processing unit 214 may utilize a heuristics approach based on one or more of the above-identified factors in determining the risk associated with a potential exposure point. Alternatively, it may utilize machine learning models that is trained to determine a risk score for an exposure point given the location of the exposure point and the extent of the likely exposure.

At step 312 a determination is made whether any of the exposure points have a risk score that is higher than a threshold risk score. If none of the exposure points have a risk score that is higher than the threshold risk score, the method 300 ends. Alternatively, if even one of the exposure points has a risk score that exceeds the threshold risk score, the method proceeds to step 314 where the processing unit 214 may be configured to issue a warning or alert to the cable owner or cable operator or a cable infrastructure user for consideration of mitigation strategies. Optionally, the processing unit 214 may also communicate an alert through an AIS to alert potential marine vessels in the region about the likely exposure locations and their radius or extend. In some examples, the alert may be communicated via the communication interface 217. The alert may include information regarding the geographic location of the cable exposure and may alert fishing and trawling vessels to be careful in that area.

In another embodiment, the processing unit 214 may provide the cable risk map to the cable operator and after receiving the cable risk map, the cable operator may flag the exposure location with a live AIS beacon to alert potential marine vessels in the region so that fishermen and maritime vessel operators would know about the increased hazard. Alternatively, other devices can be implemented to flag the coordinates of the exposure location, for example location coordinates can be transmitted via the Internet, via Emergency Position Indicating Radio Beacons (EPIRB) alerts or other quantitative information devices such as satellite devices (i.e. GPS location tracker).

In the method 300 described above, baseline measurements may be required to determine the exposure points. To this end, when a cable is first laid or buried interrogation signals may be transmitted in the sensing optical fibre and return signals may be received and processed to determine the baseline strain and/or vibration dampening properties of the optical cable when it is fully buried. This baseline strain and/or vibration dampening may be considered a threshold value and may be compared with real time strain and/or vibration dampening of the optical cable to determine differences from the baseline and identify potential exposure points. For example, if the amplitude of the signals has increased in a particular location over an extended period of time from the threshold value (e.g., baseline levels), the processing system may determine that location to be a likely exposure point.

The baseline readings may also be utilized to identify inherent zones of low or high strain (e.g., terrestrial zones or surf zones) which can be used later to label the statistical plots and mask those zones.

In some examples, the DFOS method 300 for determining exposure points may be utilized together with the DTS method described previously to increase the accuracy of the detection systems and methods.

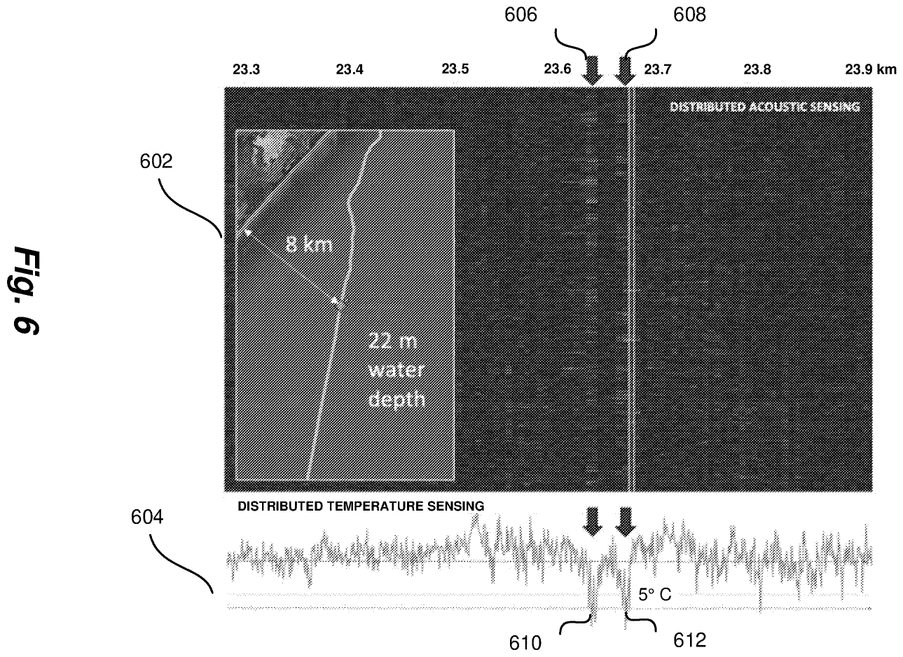

FIG. 6A shows an example of this. In this Figure, a PSD plot 602 based on DFOS data is compared with DTS data 604. Two exposure points 606, 608 35 m wide are identified 8 kms from the shore based on the DFOS data. The DTS data shows a drop in the sensed temperature at the same locations 610 and 612, indicating that DTS and DFOS data can be utilized together to detect exposure points.

Mapping the cable exposure risk as described herein has several advantages. A key advantage is that, after the identification of the exposure event shown in FIG. 5, the cable operator can flag this location to prevent or minimize aggression hazards to the cable.

Further, in the system and method described above, alternatively, acoustic data can be recorded with telecommunication receiver statistics themselves for DFOS, without a dedicated instrument at one end, to extract information related to the fibre state, such as a property of polarization or time of flight from one end to the other which might carry information about the time-rate of change of fibre length, or state of stress or strain of the fibre at a point or over its length.

It will be understood that the invention disclosed and defined in this specification extends to all alternative combinations of two or more of the individual features mentioned or evident from the text or drawings. All of these different combinations constitute various alternative aspects of the invention.

As used herein, except where the context requires otherwise, the term “comprise” and variations of the term, such as “comprising”, “comprises” and “comprised”, are not intended to exclude further additives, components, integers or steps.

1. A method for determining an exposure point along a submarine cable, the method comprising:
transmitting interrogating signals into a sensing optical fibre extending a length of the submarine cable;
receiving backscattered signals from the sensing optical fibre in response to the interrogating signals;
processing the backscattered signals to determine at least one of temporal and spatial variation in strain along the sensing optical fibre, wherein a determined at least one spatial and temporal variation in the strain is indicative of an exposure point and its location along the length of the submarine cable.

2. The method of claim 1, wherein determining the at least one of spatial and temporal variation in the strain includes: determining variations in a true amplitude and a duration of the backscattered signals at locations along a length of the optical sensing fibre.

3. The method of claim 2, further comprising detecting the exposure point by determining that the true amplitude of the backscattered signal at a location along the length of the optical sensing fibre is above a threshold value and remains above the threshold value for a threshold duration of time.

4. The method of claim 3, wherein the threshold value is determined based on a baseline strain value for the corresponding location along the length of the optical sensing fibre, the baseline strain value being determined when the submarine cable was buried.

5. The method of claim 3, further comprising determining the location of the exposure point based on timing of receiving the backscattered signal.

6. The method of claim 3, further comprising: determining a risk score associated with the detected exposure point.

7. The method of claim 6, wherein determining the risk score comprises:
determining a geographical location of the exposure point; and
determining a risk score associated with the geographical location based on contextual data.

8. The method of claim 6, further comprising: generating an alert upon determining that the risk score of the detected exposure point is above a threshold risk score.

9. The method of claim 6, further comprising generating a cable risk map based on the detected exposure point and communicating the cable risk map to an operator of the submarine cable.

10. A distributed fiber optic sensing (DFOS) system, comprising:
a light source configured to transmit interrogating signals into a sensing optical fibre extending a length of a submarine cable;
a photodetector configured to receive backscattered signals from the sensing optical fibre in response to the interrogating signals;
a processing unit configured to process the backscattered signals to determine temporal and/or spatial variation in strain along the sensing optical fibre, wherein a determined spatial and/or temporal variation in the strain is indicative of an exposure point and its location along the length of the submarine cable.

11. The DFOS system of claim 10, wherein to determine the spatial and/or temporal variation in the strain, the processing unit is further configured to determine variations in a true amplitude and a duration of the backscattered signals at locations along a length of the optical sensing fibre.

12. The DFOS system of claim 11, wherein the processing unit is further configured to detect the exposure point by determining that the true amplitude of the backscattered signal at a location along the length of the optical sensing fibre is above a threshold value and remains above the threshold value for a threshold duration of time.

13. The DFOS system of claim 12, wherein the threshold value is determined based on a baseline strain value for the corresponding location along the length of the optical sensing fibre, the baseline strain value being determined when the submarine cable was buried.

14. The DFOS system of claim 12, wherein the processing unit is further configured to determine the location of the exposure point based on timing of receiving the backscattered signal.

15. The DFOS system of claim 12, wherein the processing unit is further configured to determine a risk score associated with the detected exposure point.

16. The DFOS system of claim 15, wherein determining the risk score comprises:
determining a geographical location of the exposure point; and
determining a risk score associated with the geographical location based on contextual data.

17. The DFOS system of claim 15, wherein the processing unit is further configured to generate an alert upon determining that the risk score of the detected exposure point is above a threshold risk score.

18. The DFOS system of claim 15, wherein the processing unit is further configured to generate a cable risk map based on the detected exposure point and to communicate the cable risk map to an operator of the submarine cable.
